(19) United States
(12) Patent Application Publication
(10) Pub. No.: US 2014/0216978 A1
(43) Pub. Date: Aug. 7, 2014

(54) PRESCRIPTION PHOTO IDENTIFICATION LABELS

(71) Applicant: Datamax-O'neil Corporation, Orlando, FL (US)

(72) Inventor: Thomas G. Brahm, Apopka, FL (US)

(73) Assignee: Datamax-O'neil Corporation, Orlando, FL (US)

(21) Appl. No.: 14/168,474

(22) Filed: Jan. 30, 2014

Related U.S. Application Data
(60) Provisional application No. 61/759,649, filed on Feb. 1, 2013.

(51) Int. Cl. A61J 1/03; G09F 3/00

(52) U.S. Cl. CPC A61J 1/03; G09F 3/0292
USPC 206/534; 40/625

(57) ABSTRACT

A tamper-resistant container and tamper resistant label is disclosed. The tamper resistant label includes front, top, and back portions. The front portion includes a front top, a front bottom having a first edge in communication with a first edge of the front top. A breakable seal is disposed between the front top and front bottom. The top portion has a first edge in communication with a second edge of the front top. The back portion is in communication with the top portion and includes a back top having a first edge in communication with a second edge of the top portion, a back bottom having a first edge in communication with a second edge of the back top. A second breakable seal is disposed between the back top and the back bottom. The tamper-resistant label may include one or more indicia relating to the contents of the tamper-resistant container.

### CROSS-REFERENCE TO RELATED APPLICATION

This application claims priority from, and the benefit of, U.S. Provisional Application Ser. No. 61/759,649, filed Feb. 1, 2013, the entirety of which is hereby incorporated by reference herein for all purposes.

### BACKGROUND

1. Technical Field

The present disclosure generally relates to labels for prescription containers, and more particularly, to a label for prescription pill containers having photo identification of the prescription holder.

2. Description of Related Art

The need to eliminate errors in prescription medication administration is a very real and growing challenge in the United States and the rest of the world. The Center for Disease Control (CDC) states that 82% of American adults take at least one medication, and 29% of American adults take five or more medications. Taking the wrong medications can lead to serious complications and even death. According to the Institute of Medicine's July 2006 report, entitled “Preventing Medication Errors”, medication errors harm an estimated 1.5 million people in the United States each year, resulting in more than $3.5 billion in extra medical costs. Among the many different reasons for medication errors is erroneous patient identification.

Current prescription containers include labels having patient names and prescription identification numbers. This limits the possibilities for confirming the identity of the specific person to whom the medication is prescribed. Other techniques, such as those used by some hospitals, employ the use of a barcode scanner to scan a patient's wristband. This method is generally used as a second-step confirmation. The disadvantage of barcode scanning is that the barcode or the wristband can be damaged and hard to read. This may result in a delay of the patient getting the medication or even receiving the medication without the confirming use of the wristband scan. In addition, patients in the home may not be able to utilize barcode identification because many people do not have convenient access to barcode scanning equipment.

### SUMMARY

Embodiments of the present disclosure are presented herein which add an easy confirmation mechanism to medication dispensing without the cost and inconvenience of barcoded wristbands. In embodiments, a prescription label includes a photograph or other graphic depiction of the patient for whom the medication is intended. Optionally, the photograph may include only substantially the patient's face (e.g., a “head shot” or a “head-and-shoulders shot” and the like).

In an exemplary embodiment, the prescription label includes a front portion, a top portion, and a back portion. The front portion includes a front top and a front bottom. The front top includes a first edge in communication with a first edge of the front bottom. A front breakable seal is disposed between the front top and bottom at the first edge of the front top and first edge of the front bottom. The top portion includes a first edge in communication with a second edge of the front top. A second edge of the top is in communication with a first edge of the back portion that further has a back top and a back bottom. The back top has a second edge in communication with a first edge of the back bottom. A back breakable seal is disposed between the back top and the back bottom at the second edge of the back top and the first edge of the back bottom. A patient's photograph, or other identifying indicia, may be disposed on the prescription label.

In another aspect, a tamper-resistant label is disclosed. In some embodiments, the tamper resistant label is configured for use with a container including a base having a front face bottom surface and a selectively attachable lid having a front face top surface, the front face bottom surface and the front face top surface forming a front face when the lid is attached to the base. The tamper-resistant label includes a a front top, a front bottom having a first edge in communication with a first edge of the front top, and a front breakable seal disposed between the front top and the front bottom at the first edge of the front top and the first edge of the front bottom. In some embodiments, the tamper-resistant label includes a top portion having a first edge in communication with a second edge of the front top. In some embodiments, the tamper-resistant label includes a back top having a first edge in communication with a second edge of the top portion, a back bottom having a first edge in communication with a second edge of the back top, and a back breakable seal disposed between the back top and the back bottom at the second edge of the back top and the first edge of the back bottom.

In some embodiments, the tamper-resistant label includes personal patient indicia disposed thereon. The personal patient indicia may include a photograph of the patient, a name of the patient, an address of the patient, and/or an age of the patient. The photograph of the patient may only include substantially the patient's face. In some embodiments, the tamper-resistant label includes additional indicia disposed thereon, such as, without limitation, patient information, a medication name, medication information, warning information, prescribing doctor information, a prescription identifier, dosage information, a barcode, a QR code, a drawing of a medication, and/or a photograph of a medication.

In another aspect, a tamper-resistant container is disclosed. In some embodiments, the tamper-resistant container includes a base having a front-face bottom and one or more tab slots, and a lid having a front-face top and one or more push tabs. The one or more tab slot(s) and one or more push tab(s) are configured to selectively attach the lid to the base. When the lid and the base are attached, the front-face top and the front-face bottom form a front face. The tamper-resistant container includes a tamper-resistant label affixed to the front face. The tamper-resistant label includes a front top affixed to the front-face top of the tamper-resistant container and a front bottom affixed to the front-face bottom of the tamper-resistant container. The front bottom includes a first edge in communication with a first edge of the front top. The tamper-resistant label includes a front breakable seal disposed between the front top and the front bottom at the first edge of the front top and the first edge of the front bottom.

In some embodiments, when the base and the lid are detached, the front breakable seal is broken. In some embodiments, the lid further includes a top surface, and the tamper-resistant label further comprises a top portion fixed to the top surface. A first edge of the top portion of the tamper-resistant label is in communication with a second edge of the front top.

In some embodiments, the base further includes a back-face bottom and the lid further includes a back-face top. The tamper-resistant label includes a back top fixed to the back-face top that has a first edge in communication with a second edge of the top portion. The tamper-resistant label further includes a back bottom fixed to the back-face bottom. The back bottom includes a first edge in communication with a second edge of the back top, and a back breakable seal disposed between the back top and the back bottom at the second edge of the back top and the first edge of the back bottom.

In some embodiments, the tamper-resistant label of the tamper-resistant container includes personal patient indicia disposed thereon. The personal patient indicia may include a photograph of the patient, a name of the patient, an address of the patient, or an age of the patient. In some embodiments, the photograph of the patient includes only the patient's face, or primarily or substantially only the patient's face. In some embodiments, the tamper-resistant label further include indicia disposed thereon such as, without limitation, patient information, a medication name, medication information, warning information, prescribing doctor information, dosage information, a barcode, a QR code, a drawing of a medication, and a photograph of a medication.

### BRIEF DESCRIPTION OF THE DRAWINGS

The disclosed subject matter may take form in various components and arrangements of components, and in various steps and arrangements of steps. The appended drawings are only for purposes of illustrating exemplary embodiments, and are not to be construed as limiting the subject matter. The aspects, features, and advantages of the present disclosure will become more apparent in light of the following detailed description when taken in conjunction with the accompanying drawings in which:

FIG. 1 is a front perspective view of an exemplary prior art pill container suitable for use with embodiments of a prescription photo identification label in accordance with the present disclosure;

FIG. 2 is a front view of an embodiment of a prescription photo identification label in accordance with the present disclosure;

FIG. 3 is a front view of an embodiment of a prescription photo identification label having prescription information imprinted thereon in accordance with the present disclosure;

FIG. 4 is a front, perspective view of the prior art pill container of FIG. 1 having the prescription photo identification label of FIG. 3 disposed thereon in accordance with the present disclosure;

FIG. 5 is a top-side, perspective view of the prior art pill container of FIG. 1 with the prescription photo identification label of FIG. 3 disposed thereon in accordance with the present disclosure; and

FIG. 6 is a back, perspective view of the prior art pill container of FIG. 1 having the prescription photo identification label of FIG. 3 disposed thereon in accordance with the present disclosure.

### DETAILED DESCRIPTION

Particular embodiments of the present disclosure are described hereinbelow with reference to the accompanying drawings; however, it is to be understood that the disclosed embodiments are merely examples of the disclosure, which may be embodied in various forms. Well-known and/or repetitive functions and constructions are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. As is common in the art, the term “proximal” refers to that part or component closer to the user or operator, i.e. surgeon or clinician, while the term “distal” refers to that part or component further away from the user. In addition, as used herein in the description and in the claims, terms referencing orientation, e.g., “top”, “bottom”, “upper”, “lower”, “left”, “right”, and the like, are used with reference to the figures and features shown and described herein. It is to be understood that embodiments in accordance with the present disclosure may be practiced in any orientation without limitation. In this description, as well as in the drawings, like-referenced numbers represent elements which may perform the same, similar, or equivalent functions. Embodiments of the present disclosure are described in detail with reference to the drawings in which like reference numerals designate identical or corresponding elements in each of the several views. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure includes a prescription label having a photograph, picture, or other personally identifiable indicia of the patient. Optionally, such identifying indicia may include a photograph, such as, without limitation, a photograph of the patient's face. Such a photo may add a level of security for dispensing prescription medications and further help to ensure that the right patient receives the right prescription.

In addition, such a label may serve to assist law enforcement in determining whether narcotics and other controlled substances are in the possession of the patient to whom they were prescribed. A patient in possession of prescribed narcotics or other controlled substances may not necessarily carry personal identification, yet will often carry their prescription containers. Because it may be time consuming and difficult for law enforcement officers to determine whether a prescription is in the possession of its rightful owner, using prescription photo identification labels according to aspects of the present disclosure will enable law enforcement officers to more readily distinguish between lawful and unlawful possession of controlled substances and enable patients to avoid unwarranted entanglements with authorities.

Various embodiments of the present disclosure may enable elderly persons, or persons with limited vision, to properly identify their respective medications. Many patients are prescribed several prescriptions for one or more medical conditions. In another scenario, a husband and wife commonly have the same last name, and when looking at a prescription container, one may confuse prescription containers belonging to one's spouse with prescription containers belonging to one's self. In a related scenario, a parent and child often have the same first and last name, from which similar confusion may arise. Embodiments of the present disclosure may enable patients to quickly recognize one's own prescription containers, as well as those of family members, by verifying the prescription photo identification label.

According to further aspects of the present disclosure, such a label may serve to assist in identifying the proper patient in families with many members and/or small children. As previously mentioned, it can be easy to take or give the wrong medication to the wrong person, especially when all or multiple members of the family have the same last name. By providing the prescription photo identification labels, an extra means of confirmation, or double-check, is provided.

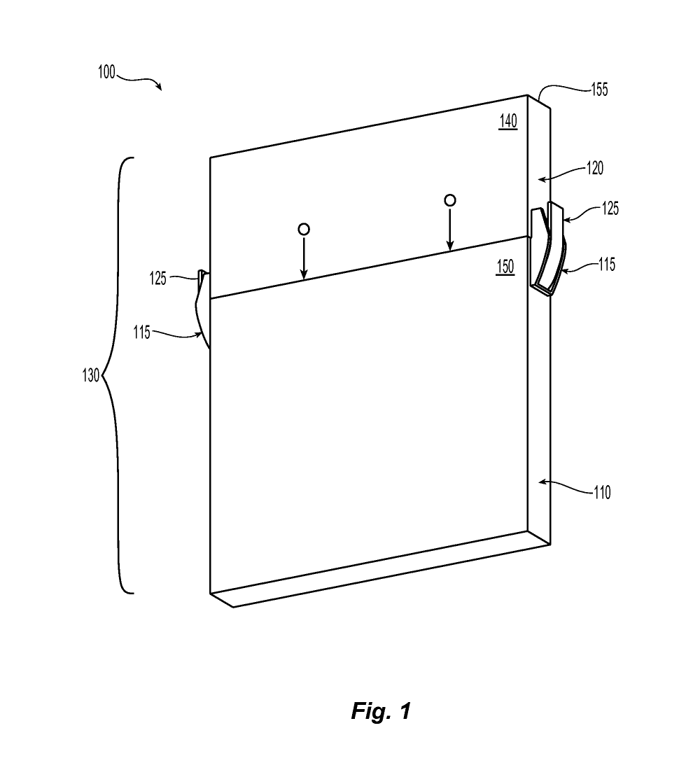

Referring to FIG. 1, prior art pill container 100 is shown. Pill container 100 includes container base 110 having tab slots 115 defined therein and container lid 120 having push tabs 125. Container 100 includes a container top 155 and a container front face 130 including front face top surface 140 and front face bottom surface 150. Container lid 120 is releasably engaged with container base 110 via push tabs 125 and tab slots 115. Tab slots 115 are adapted to receive push tabs 125. Once inserted into tab slots 115, push tabs 125 are normally biased and engaged with tab slots 115 to hold container base 110 and container lid 120 together along the opening “O”. Actuation of push tabs 125 overcomes the bias to disengage push tabs 125 and tab slots 115, allowing container lid 120 to move away from container base 110 at opening O.

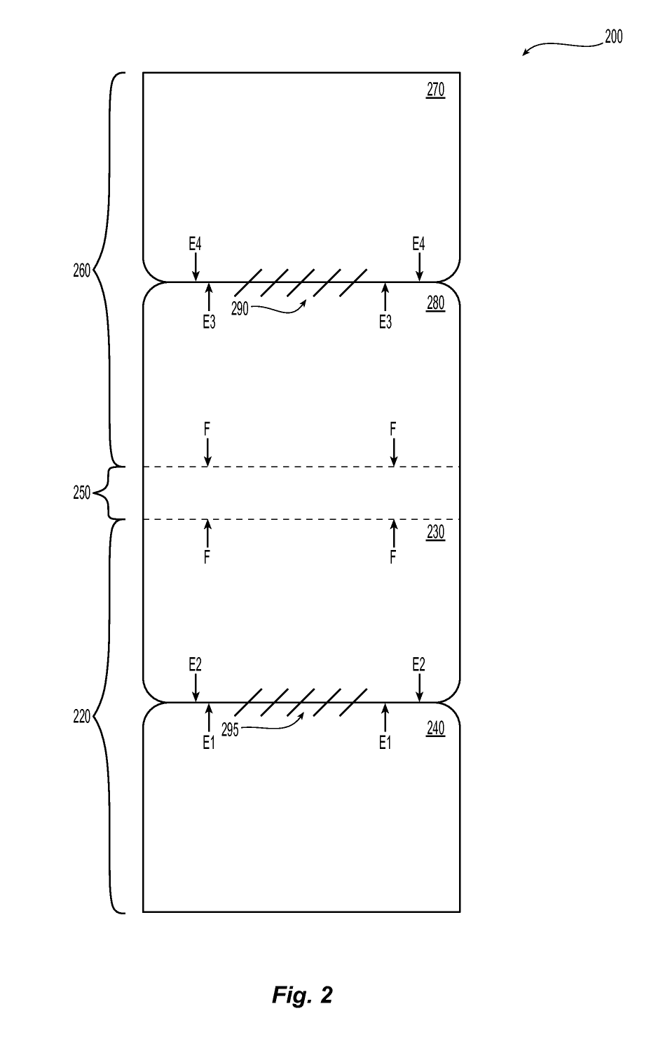

Referring now to FIGS. 2-6, a prescription photo identification label 200 includes a printable surface 210 having a front portion 220, top portion 250, and back portion 260. Front portion 220 may include front top portion 230 and front bottom portion 240. Front bottom portion 240 has an edge E1 in communication with an edge E2 of front top portion 230. A breakable seal 295 is disposed between front top portion 230 and front bottom 240 portion along edges E1 and E2. By way of illustration, breakable seal 295 may be used to indicate that container 100 has not been used, to provide assurances that container 100 has not been tampered with, and as a measure of security to authenticate that container 100 can be relied upon to contain the specific contents listed on photo identification label 200.

Back portion 260 includes back top portion 280, back bottom portion 270, and a breakable seal 290. Top portion 250 may be defined by folds, scoring, or other defining indicia as shown and designated as F in FIG. 2. Back bottom portion 270 has edge E4 in communication with edge E3 of back top portion 280. Breakable seal 290 is disposed between back top portion 280 and back bottom portion 270 at edge E3 of back top portion 280 and edge E4 of back bottom portion 270.

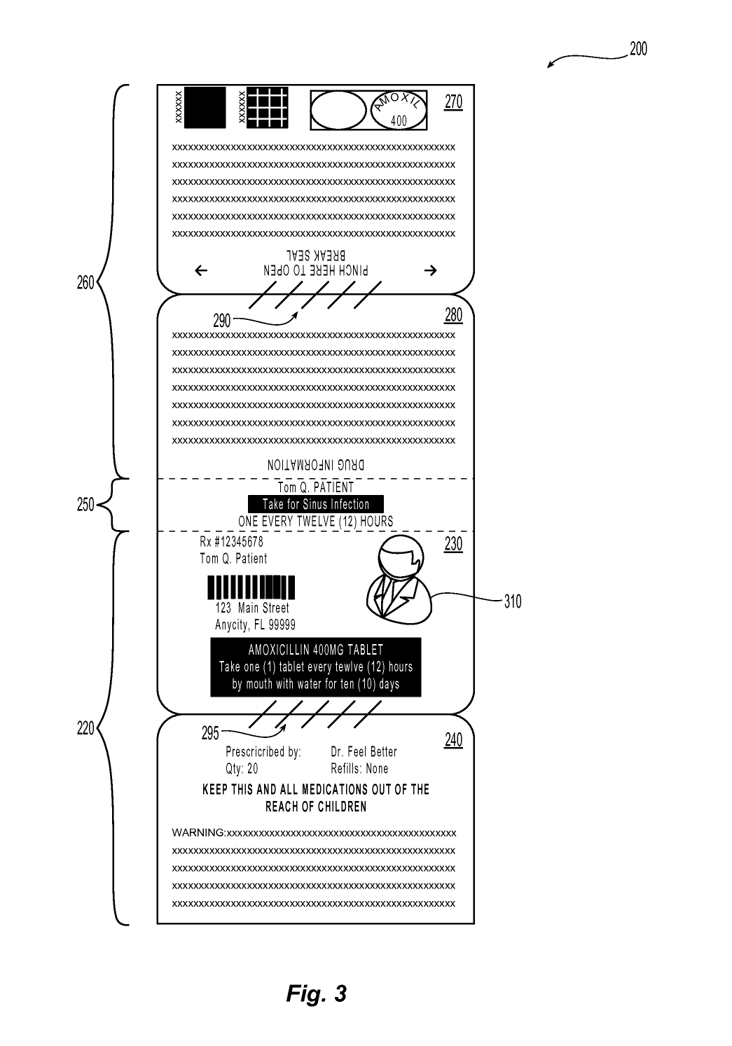

In the embodiment shown in FIG. 3, label 200 includes printed surface 210 adapted for accepting print from a printer and surface on the opposing face of the label that includes an adhesive (not shown). As shown in FIG. 3, the text and diagrams imprinted thereon may include, without limitation, patient information, drug name and information, warning information, prescribing doctor information, proper dosage and directions, QR codes, and drawings or pictures of the drug enclosed in the container. In alternative exemplary embodiments, one or more portions of the label, such as top portion 250, may be presented in a color different from other portions of the label. In this exemplary embodiment, a patient's photograph 310 may be imprinted on front top 230, however, the patient photograph 310 may be located anywhere on the printable face of label 200.

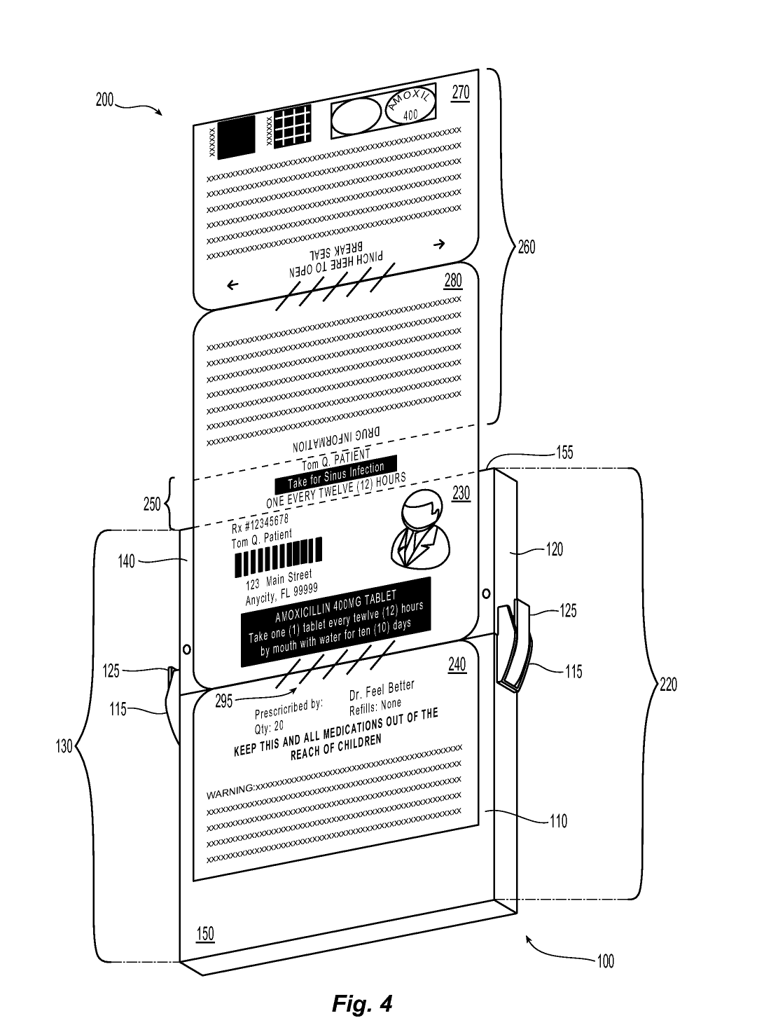

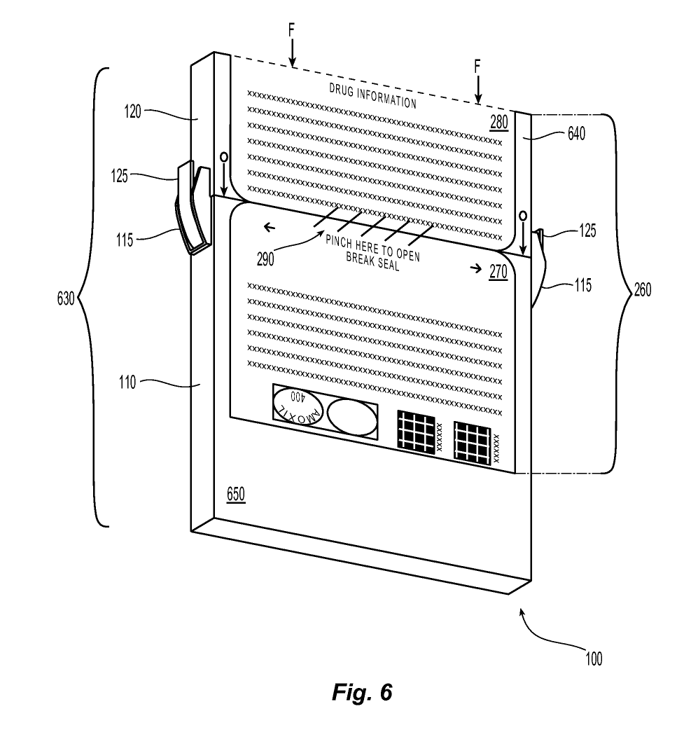

Label 200 is adapted to engage with and/or adhere to a pill container, such as, for example, pill container 100, via the adhesive surface disposed on the opposite side of label 200. As illustrated in FIG. 4, front portion 220 of label 200 is disposed on the front surface 130 of pill container 100. In this exemplary illustration, top portion 250 and back portion 260 have not yet been applied to the top surface 140 or back face 630 (FIG. 6) of pill container 100. As shown, front top portion 230 of label 200 is adhered to the container lid 120, or container front-face top surface 140. Front bottom portion 240 of label 200 is disposed on the front face 130 of container base 110, or specifically on the front-face bottom 150. Front breakable seal 295 is disposed on or near opening O.

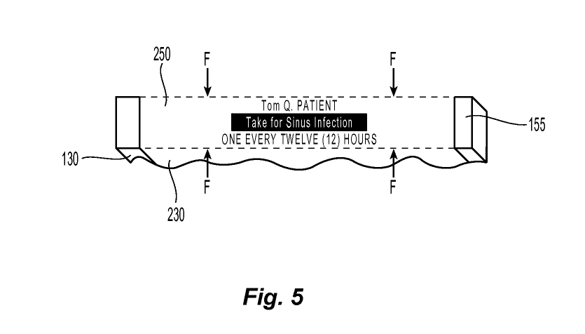

Once front portion 220 of label 200 is applied to the front surface 130 of the container, label 200 is folded along fold F (other defining indicia) located between front top portion 230 and top portion 250 of label 200. The label is then folded along fold F and then along the fold F located between top portion 250 and back portion 260 which results in top portion 250 of label 200 being adhered to container top 155, as illustrated in FIG. 5.

Once the fold F located between top portion 250 and back portion 260 of label 200 is complete, back portion 260 of label 200 is adhered to a back face 630, as shown in FIG. 6. Back top portion 280 of label 200 is disposed on the back face 630 of the container lid 120, or container back top surface 640. Back bottom portion 270 of label 200 is adhered to the back face 630 of container base 110, or container back bottom surface 650. Breakable seal 290 is disposed on or near opening O.

In use, a pharmacist opens pill container 100 by depressing both push tabs 125 to disengage container lid 120 from container base 110 and sliding container lid 120 and container base 110 into an open configuration, deposits the desired number of doses of medication into container 100, and closes pill container 100 into a closed configuration whereby push tabs 125 engage tab slots 115. A photo identification label 200 is adhered to pill container 100 as described hereinabove. In this manner, pill container 100 is effectively sealed and rendered tamper-evident by the fact that breakable seals 290, 295 are intact. Upon the first subsequent opening of pill container 100 by, e.g., a patient, breakable seals 290, 295 will rupture, thus indicating that pill container 100 is no longer sealed and/or may have been subject to tampering.

Although the illustrative embodiments of the present disclosure have been described herein with reference to the accompanying drawings, it is to be understood that the disclosure is not limited to those precise embodiments, and that various other changes and modifications may be effected therein by one skilled in the art without departing from the scope or spirit of the disclosure.

What is claimed is:

1. A tamper-resistant label for a container including a base having a front face bottom surface and a selectively attachable lid having a front face top surface, the front face bottom surface and the front face top surface forming a front face when the lid is attached to the base, the tamper-resistant label comprising:
a front top;
a front bottom having a first edge in communication with a first edge of the front top; and
a front breakable seal disposed between the front top and the front bottom at the first edge of the front top and the first edge of the front bottom.

2. The tamper-resistant label in accordance with claim 1, further comprising a top portion having a first edge in communication with a second edge of the front top.

3. The tamper-resistant label in accordance with claim 2, further comprising:
a back top having a first edge in communication with a second edge of the top portion;
a back bottom having a first edge in communication with a second edge of the back top; and
a back breakable seal disposed between the back top and the back bottom at the second edge of the backside top and the first edge of the back bottom.

4. The tamper-resistant label in accordance with claim 1, further comprising personal patient indicia disposed thereon.

5. The tamper-resistant label in accordance with claim 4, further comprising personal patient indicia disposed thereon selected from the group consisting of a photograph of the patient, a name of the patient, an address of the patient, and an age of the patient.

6. The tamper-resistant label in accordance with claim 5, wherein the photograph of the patient only includes substantially the patient's face.

7. The tamper-resistant label in accordance with claim 1, further comprising indicia disposed thereon selected from the group consisting of patient information, a medication name, medication information, warning information, prescribing doctor information, a prescription identifier, dosage information, a barcode, a QR code, a drawing of a medication, and a photograph of a medication.

8. A tamper-resistant container, comprising:
a base having a front-face bottom and at least one tab slot;
a lid having a front-face top and at least one push tab, the at least one tab slot and at least one push tab configured to selectively attach the lid to the base, wherein when the lid and the base are attached, the front-face top and the front-face bottom form a front face;
a tamper-resistant label affixed to the front face, including:
a front top affixed to the front-face top;
a front bottom affixed to the front-face bottom and having a first edge in communication with a first edge of the front top; and
a front breakable seal disposed between the front top and the front bottom at the first edge of the front top and the first edge of the front bottom.

9. The tamper-resistant container in accordance with claim 8, wherein the lid further comprises a top surface; and
the tamper-resistant label further comprises a top portion fixed to the top surface and having a first edge in communication with a second edge of the front top.

10. The tamper-resistant container in accordance with claim 9, wherein the base further includes a back-face bottom and the lid further includes a back-face top; and
the tamper-resistant label further comprising:
a back top fixed to the back-face top;
a first edge in communication with a second edge of the top portion
a back bottom fixed to the back-face bottom;
a first edge in communication with a second edge of the back top;
a back breakable seal disposed between the back top and the back bottom at the second edge of the backside top and the first edge of the back bottom.

11. The tamper-resistant container in accordance with claim 8, wherein the tamper-resistant label further comprises personal patient indicia disposed thereon.

12. The tamper-resistant container in accordance with claim 8, wherein the tamper-resistant label further comprises personal patient indicia disposed thereon selected from the group consisting of a photograph of the patient, a name of the patient, an address of the patient, and an age of the patient.

13. The tamper-resistant container in accordance with claim 12, wherein the photograph of the patient only includes substantially the patient's face.

14. The tamper-resistant container in accordance with claim 8, wherein the tamper-resistant label further comprises indicia disposed thereon selected from the group consisting of patient information, a medication name, medication information, warning information, prescribing doctor information, dosage information, a barcode, a QR code, a drawing of a medication, and a photograph of a medication.
